(19) United States
(12) Patent Application Publication
(10) Pub. No.: US 2011/0061854 A1
(43) Pub. Date: Mar. 17, 2011

(54) SUBSEA ASSEMBLY

(76) Inventor: Mark Davies, Aberdeenshire (GB)

(21) Appl. No.: 12/740,186

(22) PCT Filed: Oct. 29, 2008
(86) PCT No.: PCT/GB08/03681

§ 371 Date: Nov. 29, 2010

(30) Foreign Application Priority Data
Oct. 31, 2007 (GB) 0721352.3

(51) Int. Cl. E21B 34/04; F16K 27/00

(52) U.S. Cl. 166/95.1; 251/366

(57) ABSTRACT

A subsea assembly (11) comprises a valve assembly (12) and a winch assembly (8) mounted relative to the valve assembly (12). The valve assembly (12) comprises: a valve block (22) defining a throughbore (24); a valve member (26) mounted within the valve block (22) and adapted to be moved between open and closed positions to selectively provide a fluid barrier within the throughbore (24); and first and second valve stems (29, 31) extending from respective sides of the valve member (26) and through a side wall of the valve block (22), each valve stem (29, 31) including a sealing region in fluid communication with the throughbore (24), wherein a cross-sectional area of the sealing region of the first valve stem (29) is substantially equal to the cross-sectional area of the sealing region of the second valve stem (31). The winch assembly (8) comprises a winch chamber (9) in fluid communication with the throughbore (24) of the valve block (22), wherein the winch assembly (8) comprises a winch drum (15) carrying a spoolable member (17) adapted to extend through the throughbore (24) of the valve block (22).

### FIELD OF THE INVENTION

The present invention relates to a subsea assembly, and in particular, but not exclusively, to a subsea tool deployment assembly

### BACKGROUND TO THE INVENTION

In the oil and gas exploration and production industry, the use of subsea production systems has become the method of choice for exploiting oil and gas fields. Such systems employ Christmas trees, which are formed of valves, spools and the like, mounted directly on the wellhead at seabed level. Production from such Christmas trees may be directly communicated to a production platform or vessel, or may be collected via a subsea manifold such that production fluid from a number of wellbores may be collectively flowed to a single production platform or vessel.

Many of the fields developed with subsea production trees are moving into the second phase of production, known as the intervention phase. An intervention operation typically involves extensive production logging programmes followed by the appropriate remedial operations, such as re-perforating and water shut-off. Accordingly, an intervention operation may involve a significant number of trips into and out of the wellbore with many different tooling strings and arrangements.

The conventional approach to performing intervention operations on subsea production arrangements is to do so from a drilling rig or ship utilising a workover system incorporating a marine riser extending between the Christmas tree and the surface vessel. In such conventional approaches, isolation of wellbore fluids within the wellbore and marine riser is achieved via a BOP stack located on the surface vessel, wherein intervention tooling and the like is selected and made up at surface level and then run into the marine riser through the BOP. The BOP incorporates a number of valves, such as ram valves, shear valves, gate valves and the like which are actuated in response to, for example, pressure imbalances or fluctuations within the wellbore, in order to prevent leakage of wellbore fluids into the environment. The BOP valves are designed to sever any object, such as wireline, passing through the BOP so as to ensure complete fluid isolation. Accordingly, actuation of a BOP valve may result in the loss of a tooling string into the wellbore, necessitating an expensive and time-consuming fishing operation to retrieve the tool. However, the requirement to ensure that leakage is prevented from the BOP stack outweighs the desire to prevent loss of a tool into the well.

The valves within a BOP stack are typically hydraulically actuated and in the event of loss of hydraulic power the valves typically respond, as a precautionary measure, by closing until remedial action can be carried out in order to minimise the risk of leakage of wellbore fluids into the environment. In many known arrangements, the valves may be closed by a differential pressure acting against a valve member to urge said member towards a closed position. In this case the differential pressure may be established by wellbore pressure acting against a sealing surface of the valve member. As noted above, closure of a BOP valve may result in damage to wellbore equipment, and even the loss of equipment into the wellbore.

Furthermore, any requirement for fluid injection into the wellbore, such as well-kill fluid, is achieved directly from surface level and communicated through the marine riser.

There are many problems associated with conventional intervention systems related to, for example, the existence of the riser, the cost and availability of a suitable surface vessel, the time required to carry out an intervention operation, among others. In an attempt to alleviate such problems, the present applicant has proposed a self contained well intervention system which is adapted to be mounted directly on the Christmas tree, thus eliminating the requirement for a marine riser and associated specialist surface vessel and equipment. Such a subsea intervention system is disclosed in the applicant's international application WO 2004/065757. In a preferred system, the appropriate intervention equipment, such as wireline tools, wireline, winches and the like, are provided within a subsea vessel mounted on the wellhead, wherein the subsea vessel is exposed to and contains wellbore fluid and pressures. Accordingly, by providing all necessary components within the subsea vessel, the requirement for external access, and the concomitant risk of leakage of wellbore fluids into the surrounding water, is eliminated, or at least minimised. Consequently, the requirement for valve arrangements which automatically close upon failure may not be required given that fluid containment is achieved by the subsea vessel.

Additionally, it should be noted that the elimination of the marine riser thus also eliminates a flow path directly into the wellbore for fluid injection, such as injection of well-kill fluids.

The present invention seeks to provide fluid control apparatus which has particular application in a subsea intervention system.

### SUMMARY OF THE INVENTION

According to a first aspect of the present invention, there is provided a subsea assembly comprising:

a valve assembly comprising:
a valve block defining a throughbore;
a valve member mounted within the valve block and adapted to be moved between open and closed positions to selectively provide a fluid barrier within the throughbore;
first and second valve stems extending from respective sides of the valve member and through a side wall of the valve block, each valve stem including a sealing region in fluid communication with the throughbore, wherein a cross sectional area of the sealing region of the first valve stem is substantially equal to the cross-sectional area of the sealing region of the second valve stem; and

a winch assembly mounted relative to the valve assembly and comprising a winch chamber in fluid communication with the throughbore of the valve block, wherein the winch assembly comprises a winch drum carrying a spoolable member adapted to extend through the throughbore of the valve block.

In use, the subsea assembly may be adapted to be mounted, either directly or indirectly, on a subsea wellhead, such that the valve assembly may provide fluid control between the valve assembly and a well bore through the wellhead. Additionally, the winch assembly may deliver and retrieve the spoolable member to and from the well bore.

As each valve stem is in fluid communication with the throughbore of the valve block, each sealing region will therefore be exposed to substantially the same fluid pressure. The pressure acting on each sealing region will therefore apply substantially equal forces on the first and second valve stems and as such a force equilibrium will be established. Accordingly, the valve stems will not be biased in any particular direction by fluid pressure within the throughbore to move the valve member. In this respect, in the event of a loss of valve control, such as the failure or loss of actuator hydraulic, pneumatic, or electric power or the like, the valve member will remain in the same position. The valve assembly may be conveniently termed “fail-as-is”. This arrangement prevents or substantially minimises the possibility of the valve member inadvertently closing on a spoolable member extending through the valve assembly.

In one embodiment the spoolable member is adapted to provide support for a downhole tool such that said downhole tool may be deployed and retrieved utilising the spoolable member.

The subsea assembly may further comprise a tool storage assembly mounted relative to the valve assembly and comprising a tool storage chamber in fluid communication with the throughbore of the valve block. The tool storage chamber may contain at least one downhole tool adapted to be secured to the spoolable member to subsequently be deployed into the well bore. The at least one tool may comprise an intervention tool, for example, or any tool adapted to perform a required in-well operation. The at least one tool may be adapted to travel through at least a portion of the throughbore of the valve block.

The first and second valve stems may extend from opposing sides of the valve member. The first and second valve stems may be arranged to be colinear.

The sealing region of each valve stem may engage respective stem sealing arrangements adapted to prevent fluid leakage from the throughbore past each valve stem.

The valve block may define first and second lateral bores extending through an outer wall portion of the valve block and opening into the longitudinal bore, wherein the first and second valve stems extend through the first and second lateral bores respectively. The valve stems are preferably adapted to be translated relative to the respective lateral bores.

A valve stem sealing arrangement may be disposed between the sealing regions of each valve stem, respectively, and the first and second lateral bores, respectively. This arrangement therefore establishes the valve stems to be in sealing engagement with a respective lateral bore.

Alternatively, the lateral bores may define a larger cross-sectional area than the valve stems such that first and second fluid cavities are defined between an outer surface of a respective valve stem and an inner surface of a respective lateral bore. The fluid cavities may be annular. In a preferred embodiment, each fluid cavity is in fluid communication with the longitudinal bore of the valve block such that each fluid cavity and valve stem is, in use, exposed to fluid pressure within said longitudinal throughbore.

The valve assembly may further comprise first and second cap members adapted to be secured to the outer surface of the valve block to cover and seal a respective lateral throughbore. At least one of the cap members may be formed separately from the valve block and subsequently secured thereto, for example by bolting, welding, screwing or the like. A sealing arrangement such as a metal-to-metal seal, gasket or the like is preferably provided between each cap member and the outer surface of the valve block. At least one of the cap members may be integrally formed with the valve block.

Each cap member may be adapted to receive a portion of a respective valve stem. Preferably, each cap member defines a bore adapted to receive a portion of a respective valve stem, wherein the valve stem is slidably engaged within the bore. A valve stem sealing arrangement may be disposed between the sealing regions of each valve stem and a respective bore of each cap member. This arrangement therefore establishes the valve stems to be in sealing engagement with a respective bore of the cap members.

In one embodiment, at least one, and preferably both of the cap members defines a stepped bore, with a first bore section of a first diameter, and a second bore section of a second, larger diameter. Advantageously, a valve stem sealing arrangement may be disposed between respective valve stems and respective first bore sections, wherein a fluid cavity may be defined between the valve stem and the second bore section. In one embodiment, this fluid cavity within the cap member may advantageously combine with or open into the fluid cavity defined between the valve stem and respective lateral bore in the valve block. It should be understood that terms such as diameter are used herein for clarity and convenience and as such are not intended to limit the scope of the invention, or features of the invention to being round in cross-section. Accordingly, non-round geometries are also envisaged.

The valve member may be moveable between open and closed positions via at least one of the first and second valve stems.

The valve assembly may further comprise a valve actuator. One or both of the first and second valve stems may be coupled, either directly or indirectly, to a valve actuator. In one embodiment, at least a portion of a valve actuator may be mounted on a side wall of the valve block, and more preferably on one, or alternatively both of the cap members. The valve assembly preferably comprises a hydraulic actuator. The hydraulic actuator may comprise an actuator piston arrangement. In one embodiment, one of the first and second valve stems may form part of a hydraulic actuator, such as an actuator piston arrangement.

Alternatively, the valve actuator may comprise an electrical actuator, such as a solenoid arrangement, pneumatic actuator or the like.

The valve actuator may be adapted to be manually operated, for example via a submersible Remotely Operated Vehicle (ROV). Accordingly, in the event of failure of the valve actuator, for example as a result of loss of power, hydraulic or otherwise, the valve may still be operated as desired. Advantageously, the valve actuator may comprise an ROV interface permitting engagement and operation by an ROV.

The valve may comprise a gate valve.

The subsea assembly may be adapted to be mounted on a wellhead Christmas tree, such as a horizontal or vertical tree. In one embodiment the valve assembly of the subsea assembly is adapted to be mounted on a Christmas tree. Alternatively, the winch assembly, or any other component or part of the subsea assembly is adapted to be mounted on a Christmas tree.

The valve assembly may be adapted to be in fluid communication with a production bore of the Christmas tree, and preferably also an annulus bore of the tree. In a preferred arrangement, the valve assembly permits fluid communication from both the production and annulus bores of a conventional Christmas tree through and/or past said valve assembly. The longitudinal bore of the valve block is preferably in fluid communication with a tree production bore. Fluid communication may be achieved by an isolation sleeve extending between the throughbore of the valve block and a production bore of a Christmas tree. The isolation sleeve may isolate the production bore from the annulus bore of the Christmas tree.

The valve assembly of the present invention may be adapted to be mounted on a Christmas tree via a suitable tree connector, which is known in the art for conventional Christmas trees.

In one arrangement the valve assembly may be adapted to be mounted on a single type of Christmas tree, such as a horizontal tree or a vertical tree or the like. Preferably, the valve assembly is adapted for use on different types of Christmas tree, such as both a horizontal and vertical type tree.

It is well known in the art that horizontal trees incorporate a central production bore and an annulus bore passage extending axially through a wall portion of the tree. In a preferred embodiment, the throughbore of the valve block is aligned with a central axis of said valve block, such that, in use, the production bore of a horizontal Christmas tree may be axially aligned with the throughbore of the valve block.

In contrast, a conventional vertical or dual bore Christmas tree incorporates parallel production and annulus bores, arranged side-by-side and both off-set from the central axis of the Christmas tree. In embodiments where the throughbore of the valve block is centrally aligned, said bore will be off-set from the production bore of a vertical Christmas tree. The valve assembly may be provided in combination with an adaptor, conveniently termed herein a cross-over adaptor, for permitting use of the valve assembly on various types of Christmas trees, preferably a vertical Christmas tree.

The cross-over adaptor may, in use, align the production bore of a Christmas tree, for example a vertical Christmas tree, with the throughbore of the valve block. The cross-over adaptor may comprise a first throughbore adapted to communicate with both the production bore of a Christmas tree and the throughbore of the valve block. The adaptor may further comprise a second throughbore adapted to communicate with the annulus bore of a Christmas tree. In embodiments where the adaptor is for use with a vertical Christmas tree, the first and second throughbores may be off-set from the central axis of the adaptor.

The first throughbore may be obliquely aligned relative to the central axis of the adaptor. In this arrangement, the obliquely aligned bore may centralise the production bore of the Christmas tree with the throughbore of the valve block.

Alternatively, and in a preferred embodiment, the first throughbore may be aligned parallel with the central axis of the adaptor. This arrangement facilitates easier manufacture of the adaptor. The adaptor may comprise a body portion and a flange adapted to be secured to the valve block. The flange may be off-set from the body portion such that the first bore is aligned with a central axis of the flange. Accordingly, the off-set flange permits the first bore to become aligned with the throughbore of the valve block when said valve block is secured to the adaptor via the flange.

The valve assembly may be secured to a Christmas tree via a conventional tree connector, such as an H4 connector, dual bore connector or the like. A cross-over adaptor, such as the one described above, may be interposed between the valve block and the tree connector. The cross-over adaptor may be separately formed and subsequently secured to the tree connector. Alternatively, the cross-over adaptor may be integrally formed with the tree connector.

In one embodiment the valve assembly comprises a fluid passage, hereinafter an annulus passage for convenience, which, in use, may be in fluid communication with an annulus bore of a Christmas tree. At least a portion of the annulus passage may be formed within the valve block. Alternatively, or additionally, at least a portion of the annulus passage may be formed externally of the valve block. In this arrangement at least a portion of the annulus passage may comprise a conduit, such as a pipe or the like.

The annulus passage may by-pass the valve member. The annulus passage may extend from a region below the valve member to a region above the valve member. The annulus passage may be coupled to the valve block below and/or above the valve member. In one embodiment, the annulus passage may be coupled to the valve block at a location below the valve member and coupled to a further component mounted on the valve assembly above the valve member.

The provision of an annulus passage permits communication through the annulus bore to be achieved, even with the valve assembly in place coupled to a Christmas tree. This arrangement permits a conventional riser to be coupled in fluid communication with a tree without requiring the valve assembly to be removed.

The subsea assembly may form part of a tool deployment system and the valve assembly may be adapted to support components of the tool deployment system, such as the winch assembly, a tool storage package, a downhole tool, a plug-pulling tool or the like, or any suitable combination thereof.

The valve block of the valve assembly may comprise at least one port in a side wall thereof. The at least one port may permit fluid access into the throughbore of the valve block. In one embodiment, the at least one side port may comprise a well-kill fluid port adapted to permit a well-kill fluid to be introduced into the throughbore of the valve block and ultimately into the wellbore. This arrangement is particularly advantageous in subsea tool deployment apparatus in that conventional access from a drilling vessel through a BOP is not permitted due to the absence of a marine riser and the access restrictions imposed by the component of the subsea apparatus.

The valve assembly may comprise a quick connector arrangement adapted to permit a robust connection between a well-kill fluid conduit extending from a well-kill fluid source and the well-kill side port. The well-kill fluid source may be located subsea or alternatively at surface level. The quick connector arrangement may also be adapted for quick release, which may be beneficial in circumstances where a source of well-kill fluid is provided on a surface vessel. Accordingly, deviation of the vessel from its intended location may result in a quick disconnect of the well-kill fluid conduit to prevent damage to the conduit and leakage of fluids into the environment.

The at least one side port may comprise a purging fluid port adapted to permit purging fluid to be introduced into the throughbore of the valve block to purge fluids, such as well bore fluids, from the subsea assembly, such as subsea intervention apparatus.

The at least one side port may comprise a methanol injection port. Alternatively, or additionally, the at least one port may comprise a pressure testing port adapted to permit pressurised fluid to pressure text gasket connections and the like, for example between the valve block and a tree connector.

In view of conventional Christmas tree arrangements, the subsea assembly may be adapted to be mounted above a Christmas tree. However, in alternative arrangements the subsea assembly may be adapted to be mounted to the side of a Christmas tree.

The subsea assembly may comprise a connector which replicates a Christmas tree connector, such as a landing string latch. In this arrangement, when the subsea assembly is secured to a Christmas tree, additional components or apparatus adapted to be coupled to a Christmas tree may be coupled to the tree via the subsea assembly, without the requirement for connection adaptors. The connector of the subsea assembly may be integrally formed with a component of said assembly, such as the valve block. Alternatively, the connector may be separately formed and subsequently secured to the valve block. In one embodiment the connector may be formed on an apparatus mounted on the valve assembly, such as a plug pulling tool. The provision of a conventional Christmas tree connector provided on or in conjunction with the valve assembly advantageously permits a conventional workover riser to be secured to the Christmas tree without requiring the valve assembly to be removed.

The valve assembly may further comprise a shearing arrangement adapted to shear a solid object, such as the spoolable member or a tool or the like extending through the valve assembly. The shearing arrangement may comprise a shear/seal ram (SSR) which is known in the art. Preferably, the SSR is positioned below the valve member.

The subsea assembly may further comprise a sensor adapted to sense the passage of an object therethrough. In a preferred embodiment, the sensor is mounted within the throughbore of the valve block, preferably, but not exclusively, below the valve member. Accordingly, the sensor may sense an object, such as a tool string, tractor or the like, which has passed the valve member while being run into a wellbore on the spoolable member. Accordingly, the object may be run into the wellbore at a relatively slow rate of advancement until the object is detected by the sensor, indicating that the valve member has been cleared, following which the rate of advancement may be increased. Furthermore, when an object is being retrieved from a wellbore, detection by the sensor will indicate that the object is approaching the valve member and as such the rate of retrieval may be reduced to prevent or substantially minimise snagging or the like of the object on the valve member.

The sensor may comprise an inductive sensor or antenna and may comprise a wound coil. In one embodiment, the sensor may be adapted to sense a target on a passing object. For example, the target may comprise a passive, inductively resonant target. The target may comprise a coil, which coil may be wound in series with a capacitor. The target may comprise a unique frequency or other identifiable characteristic such that the target may be uniquely identified. This arrangement may therefore be utilised to permit sensing of different objects or different regions of a single object. In use, the sensor forms an excitation and sensing filed which is arranged to excite and detect the presence/absence of the target as well as the target's frequency or identifiable characteristic.

The spoolable member may comprise wireline. Alternatively, or additionally, the spoolable member may comprise coiled tubing.

According to a second aspect of the present invention, there is provided a valve assembly comprising:

a valve block defining a throughbore;

a valve member mounted within the valve block and adapted to be moved between open and closed positions to selectively provide a fluid barrier within the throughbore; and

first and second valve stems extending from respective sides of the valve member and through a side wall of the valve block, each valve stem including a sealing region in fluid communication with the throughbore, wherein a cross sectional area of the sealing region of the first valve stem is substantially equal to the cross-sectional area of the sealing region of the second valve stem.

According to a third aspect of the present invention, there is provided a subsea assembly comprising:

a valve assembly comprising a valve block defining a longitudinal throughbore adapted to be in communication with a wellbore and a lateral bore extending through a wall portion of the and opening into the longitudinal bore to be in fluid communication therewith and with the wellbore; and

a winch assembly mounted above the valve assembly and comprising a winch chamber in fluid communication with the throughbore of the valve block, wherein the winch assembly comprises a winch drum carrying a spoolable member adapted to extend through the throughbore of the valve block.

The bore may be or define a well-kill fluid bore adapted to permit well-kill fluid to be communicated into the subsea fluid control assembly and ultimately into a wellbore. This arrangement is particularly advantageous in subsea intervention apparatus in that conventional access from a drilling vessel through a BOP is not permitted due to the absence of a marine riser and the access restrictions imposed by the winch assembly mounted above the valve assembly.

The valve assembly may comprise a valve assembly defined according to the first and second aspects.

According to a fourth aspect of the present invention, there is provided a cross-over adapted to be coupled between a dual bore Christmas tree and a subsea assembly, said cross-over comprising:

a body portion adapted to be secured to a Christmas tree;

a flange portion formed with the body portion and adapted to be secured to a subsea assembly; and

first and second throughbores extending through the body and flange portions wherein said throughbores are off-set from a central axis of the body portion;

wherein the flange is off-set from the body portion such that the first throughbore bore is aligned with a central axis of the flange.

The subsea assembly may comprise an assembly according to the first aspect.

The first and second throughbores of the cross-over may be adapted to be in fluid communication with a respective bore of a dual bore Christmas tree. It is well known in the art that a dual bore Christmas tree, also known as a vertical tree, incorporates a production bore and an annulus bore. Accordingly, in use, the cross-over may be utilised to align the production bore of a Christmas tree, preferably a vertical Christmas tree, with a throughbore of, for example, a throughbore of the subsea assembly.

According to a fifth aspect of the present invention, there is provided a subsea tool deployment assembly comprising:

a subsea assembly according to the first aspect; and

a tool storage assembly mounted relative to the subsea assembly and comprising a tool storage chamber in fluid communication with the throughbore of the valve block, wherein the tool storage chamber contains at least one downhole tool adapted to be secured to the spoolable member.

### BRIEF DESCRIPTION OF THE DRAWINGS

These and other aspects of the present invention will now be described, by way of example only, with reference to the accompanying drawings, in which:

FIG. 1 is a diagrammatic representation of a subsea assembly in accordance with an embodiment of an aspect of the present invention;

FIG. 2 is a perspective view of a portion of the subsea assembly shown in FIG. 1;

FIG. 3 is a longitudinal cross-sectional view of the portion of the subsea assembly shown in FIG. 2;

FIG. 4 is a longitudinal cross-sectional view of the subsea assembly shown in FIG. 2, taken through line 4-4 of FIG. 3; and

FIG. 5 is a longitudinal cross-sectional view of a portion of alternative subsea assembly incorporating a valve assembly shown in FIGS. 2, 3 and 4 and a connector adaptor according to an embodiment of an aspect of the present invention.

### DETAILED DESCRIPTION OF THE DRAWINGS

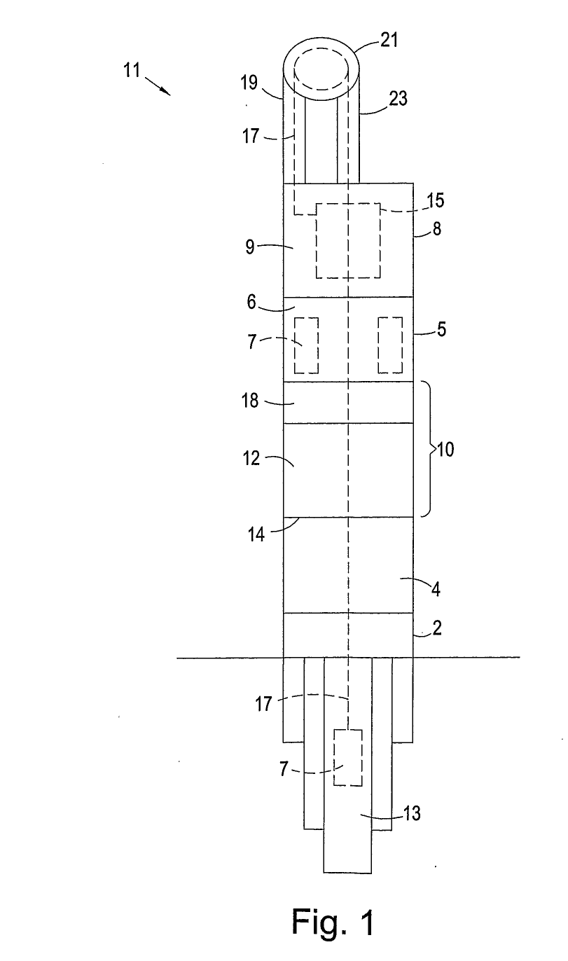

Reference is first made to FIG. 1 of the drawings in which there is shown a subsea assembly, generally identified by reference numeral 11, in accordance with an embodiment of an aspect of the present invention. The subsea assembly 11 in the embodiment shown is a self contained subsea tool deployment assembly and is shown mounted on a wellhead 2 of a well bore 13, via a Christmas tree 4. As will be described in detail below, the tool deployment assembly 11 is adapted to deploy and retrieve tools into and from the well bore 13 to perform in-well operations, such as intervention operations or the like.

The exemplary tool deployment assembly 11 of the invention comprises a valve assembly 12 which incorporates means for controlling fluid flow to and from the well bore 13. The valve assembly 12, which will be described in detail below, is mounted on the Christmas tree 4 via a conventional connector 14. Mounted immediately above the valve assembly 12 is a plug pulling tool 18 which, in use, is adapted to remove and set plugs within the Christmas tree 4. In the exemplary embodiment shown, the valve assembly 12 and plug pulling tool 18 together define a well control package 10.

A tool storage assembly 5 is mounted above the plug pulling tool 18 and includes a tool storage chamber 6 which contains a plurality of downhole tools 7. The tool storage chamber 6 is in fluid communication with the well bore 13 via the well control package 10, Christmas tree 4 and well head 2 and as such the stored tools 7 are exposed to bore fluids.

A winch assembly 8 is mounted above the tool storage assembly 5 and comprises a winch chamber 9 within which is located a vertically mounted winch drum 15 which carries a spool of wireline 17. In use, the wireline 17 extends upwardly from the winch chamber 9 through a first lubricator tube 19, over a sheave 21 and down through a second lubricator tube 23. The winch chamber 9 is in fluid communication with the tool storage chamber 6 via the lubricator tubes 17, 23 and sheave 21. The wireline 17 then extends through a central axis of the winch drum 15, and into the chamber 6 of the tool storage assembly 5. In use, a tool 7 is selected from the tool chamber 6 and secured to an end of the wireline 17 and subsequently run into the well bore 13, as shown in FIG. 1, through the well control package 10, Christmas tree 4 and well head 2.

As all components of the assembly 11 are in fluid communication with each other and thus with the well bore 13, the assembly 11 is therefore fully self-contained.

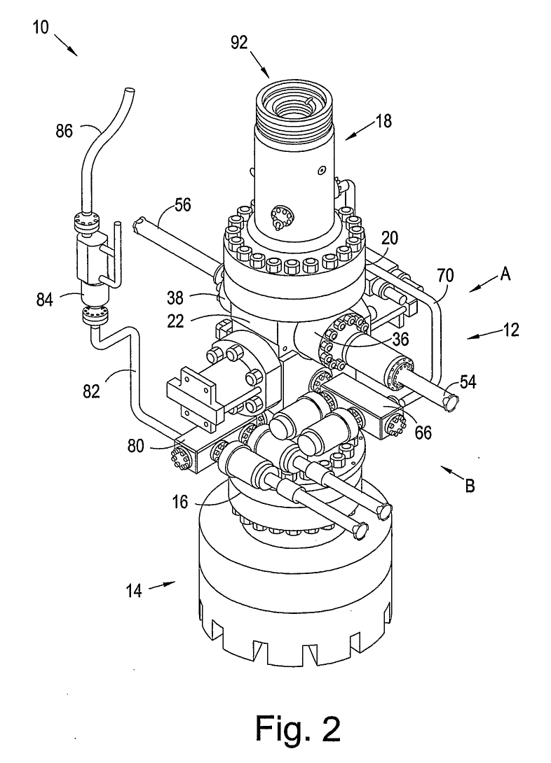

The well control package 10 will now be described in further detail, initially with reference to FIG. 2. As noted above, the package 10 incorporates a valve or fluid control assembly 12 which is mounted on a Christmas tree connector 14 via a flanged connection 16, such that the valve assembly 12 may be secured to the Christmas tree (not shown) via said connector 14. The valve assembly 12 may be secured to either a horizontal or vertical Christmas tree, as will be discussed in detail hereinafter. The plug pulling tool 18 is mounted on the valve assembly 12 via a flanged connection 20.

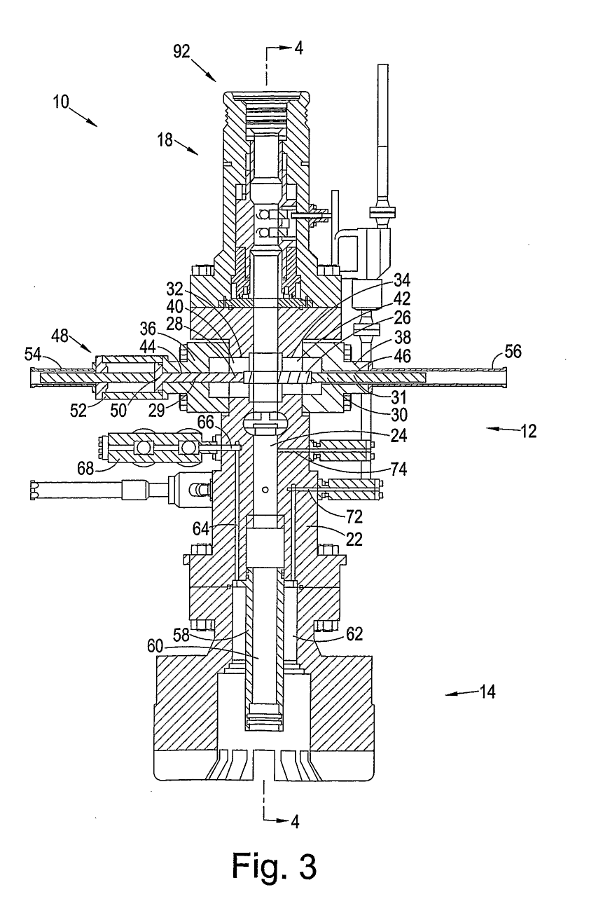

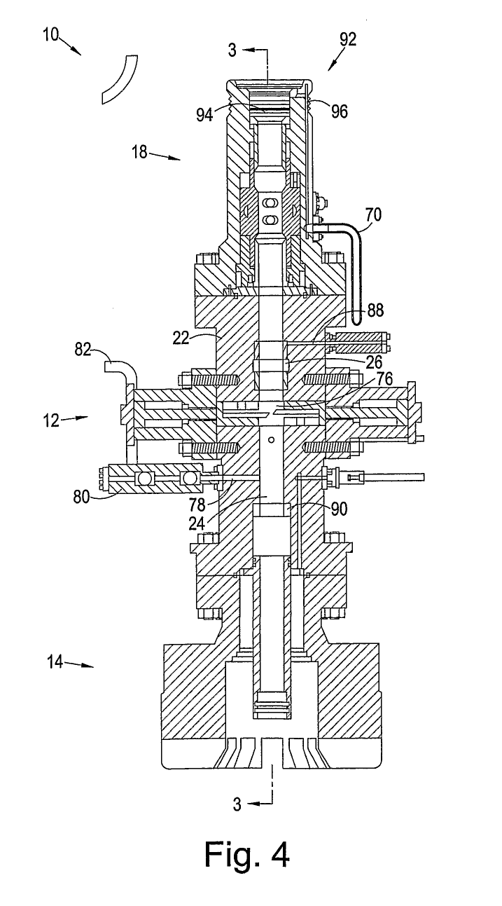

Cross-sectional views through the well control package 10 are shown in FIGS. 3 and 4 which will be discussed in detail below. However, the relative locations of external components of the well control package 10 can be readily identified in FIG. 2 and as such reference to FIG. 2 may be made during the following discussion.

Reference is now additionally made to FIG. 3 of the drawings in which there is shown a longitudinal cross-sectional view of the well control package 10 of FIG. 2. The cross-section in FIG. 3 is viewed in the direction of arrow A of FIG. 2. The valve assembly 12 comprises a valve block 22 defining a longitudinal throughbore 24 within which is slidably mounted a valve member 26 in the form of a gate valve member. The longitudinal bore 24 is adapted to be in fluid communication with a production bore of the Christmas tree (not shown), wherein the valve assembly 12 is adapted to provide a degree of fluid control between the well control package 10 and the Christmas tree production bore. A pair of valve stems 28, 30 extend from opposite sides of the valve member 26 and extend through respective lateral bores 32, 34 in the valve block 22. Each valve stem 28, 30 includes a respective sealing region 29, 31, wherein the lateral cross-sectional area of the sealing regions 29, 31 are substantially equal which permits fluid pressure applied against each valve stem 28, to establish equal and opposite forces, which therefore prevents any movement of the valve member 26 by virtue of bore pressure, as will be discussed in further detail below.

First and second cap members or bonnets 36, 38 are secured, by bolting, to the side of the valve block 22 to cover and seal respective bores 32, 34. The cap members 36, 38 and respective lateral bores 32, 34, in combination with the valve stems 28, 30, collectively define first and second annular chambers 40, 42. Each annular chamber 40, 42 is in fluid communication with the longitudinal bore 24 such that the valve stems 28, 30 are exposed to bore fluid pressure.

Each cap member 36, 38 defines a throughbore 44, 46 within which a respective valve stem 28, 30 is slidably mounted. Specifically, the sealing regions 29, 31 of the respective valve stems 28, 30 are mounted within a respective throughbore 44, 46. A sealing arrangement is defined between each valve stem 28, 30 and respective bores 44, 46, wherein the cross-sectional sealing area defined by the sealing arrangement for each valve stem 28, 30 and bore 44, 46 is substantially equal. Accordingly, when each sealing arrangement between the valve stems 28, 30 and respective cap members 36, 38 is exposed to fluid pressure within the longitudinal bore 24, no pressure force differential will be established. Accordingly, no movement of the valve stems 28, 30 and thus valve member 26 will occur by virtue of bore pressure alone. In this respect, in the event of a loss of valve control, such as the failure or loss of actuator hydraulic, pneumatic, or electric power or the like, the valve member 26 will remain in the same position. In this arrangement, the valve assembly 12 may be conveniently termed “fail-as-is”. The ability to provide such a “fail-as-is” valve assembly within a well control package 10 is permitted, at least in terms of safety, as fluid communication upwardly past the valve member 26 will be contained within the entire subsea assembly 11 (FIG. 1). This is in contrast with conventional topside BOPs where any valve assembly is required to have a failure mode resulting in the closure of the valve to prevent a blow-out and leakage of fluids into the environment.

Additionally, the arrangement provided by the present invention prevents or substantially minimises the possibility of the valve member 26 unnecessarily closing on the wireline 17 (FIG. 1) or on a downhole tool 7 (FIG. 1) which would otherwise result in loss of the tool 7 into the wellbore 13 which is extremely undesirable.

The valve assembly 12 further comprises a hydraulic valve actuator 48 adapted to displace the valve member 26 between open and closed configurations. The valve actuator 48 comprises a hydraulic piston arrangement mounted on the cap member 36, wherein an end portion of valve stem 28 defines a piston 50 slidably mounted within a cylinder 52. In use, hydraulic pressure from an external source may act on the piston 50 to displace the valve stem 28 and thus valve member 26.

The valve assembly 12 further comprises respective ROV interfaces 54, 56 mounted on each cap member 36, 38. Accordingly, in the event of failure of the valve actuator 48, for example as a result of loss of hydraulic power, the valve assembly 12 may still be operated as desired.

In the embodiment shown in FIG. 2 the valve assembly 12 is configured for use with a horizontal Christmas tree (not shown). It is well known in the art that horizontal trees incorporate a production bore which is aligned with the central axis of the tree. As noted above, the longitudinal bore 24 of the valve assembly is in fluid communication with the production bore of a Christmas tree which is achieved via an isolation sleeve 58 which in use extends between a lower portion of the longitudinal bore 24 and an upper portion of a tree production bore (not shown). The isolation sleeve 58 isolates a production bore flow path 60 from an annulus bore flow path 62.

The valve assembly 12 further comprises an annulus fluid passage 64 extending generally axially upwardly through a wall portion of the valve block 22. A lower end of the annulus fluid passage 64 opens into the annulus bore flow path 62 and as such in use is in fluid communication with the annulus bore of the Christmas tree. The annulus fluid passage 64 extends outwardly through the side wall of the valve block 22 via a port 66 positioned below the valve member 26. A dual gate valve assembly block 68 is mounted on the valve assembly 12 at the location of the port 66 and in use selectively controls fluid communication to and from the annulus bore of the Christmas tree. A conduit 70, shown in FIG. 2, extends between the dual gate valve block 68 and the plug pulling tool 18 such that fluid communication to and from the annulus bore of the Christmas tree may be achieved passed the valve member 26. The provision of an annulus passage permits communication through the annulus bore to be achieved, even with the valve assembly 12 in place coupled to a Christmas tree. This arrangement permits a conventional riser and/or other conventional components or equipment to be coupled in fluid communication with a tree without requiring the valve assembly 12 to be removed.

The valve assembly comprises additional side ports to permit communication of various fluids to and from the valve assembly 12 and well control package 10. For example, side port 72 is provided to permit purge fluid to be communicated to and from the well control package 10. Additionally, side port 74 is provided to permit methanol to be injected into a lower portion of the valve block 22 of the valve assembly 12. Further ports which cannot be seen in the cross-sectional plane of FIG. 2 are also present, some of which will be discussed hereinafter.

Reference is now made to FIG. 4 of the drawings in which there is shown a further cross-sectional view of the well control package 10 of FIG. 2, in this case taken through line 4-4 of FIG. 3 and generally viewed in the direction of arrow B in FIG. 2. The valve assembly 12 further comprise a shearing arrangement incorporating a shear/seal ram (SSR) 76 adapted to shear a solid object, such as wireline or a tool or the like extending through the valve assembly 12. SSRs are known in the art and as such no further description will be given.

Positioned below the SSR 76 is a further port 78 which extends between the longitudinal bore 24 and an outer surface of the valve block 22. Port 78 is adapted to permit a well-kill fluid to be introduced into the longitudinal throughbore 24 and ultimately into the wellbore. This arrangement is particularly advantageous in subsea tool deployment apparatus in that conventional access from a drilling vessel through a BOP is not permitted due to the absence of a marine riser and the access restrictions imposed by the intervention vessel which is mounted above the valve assembly.

Fluid communication of well-kill fluid is controlled by a dual gate valve assembly block 80 which is mounted on the valve block 22 of the valve assembly 12. A conduit 82 extends from the gate valve assembly block 80. A portion of the conduit 82 is shown in FIG. 4. However, a complete view of the conduit 82 is provided in FIG. 2. Mounted on an upper end of the conduit is a quick connect/release mechanism 84 which permits a supply conduit 86 to be readily connected and disconnected from conduit 82. For example, in embodiments where the supply conduit 86 extends from a surface vessel, the supply conduit 86 may be quickly released in circumstances where deviation of the vessel from its intended location occurs to thus prevent fracture of one or both of the conduits 82, 86.

Referring again to FIG. 4, the valve block 22 further comprises an additional port 88 extending through the wall thereof at a location above the valve member 26. The port 88 is adapted to permit methanol to be injected into the throughbore 24 above the valve member 26 to thus dissolve any hydrates which may have been deposited around the valve member 26.

Referring still to FIG. 4, the valve assembly 12 further comprises a sensor 90 mounted within the longitudinal throughbore 24 of the valve block 22, below both the valve member 26 and the SSR 76. The sensor 90 is adapted to sense the passage of an object, such as a tool 7 shown in FIG. 1, or alternatively, or additionally, a tool string, tractor or the like. Thus, the sensor 90 may sense the tool 7, which has passed the valve member 26 while being run into the well bore 13. Accordingly, the tool may be run towards the well bore 13 at a relatively slow rate of advancement until the tool 7 is detected by the sensor 90, indicating that the valve member 24 and SSR 76 have been cleared, following which the rate of advancement may be increased to run the tool into the well bore 13. Furthermore, when a tool 7 is being retrieved from the well bore 3 back through the valve assembly 12, detection by the sensor 90 will indicate that the tool 7 is approaching the valve member 26 and SSR 76 and as such the rate of retrieval may be reduced to prevent or substantially minimise snagging or the like of the tool 7 within the valve assembly 12.

In the embodiment shown, the sensor 90 is an inductive sensor adapted to sense a target on a passing tool. For example, the target may comprise a passive, inductively resonant target which may comprise a unique frequency such that the target may be uniquely identified. This arrangement may therefore be utilised to permit sensing of different tools or different regions of a single tool. In use, the sensor 90 forms an excitation and sensing field which is arranged to excite and detect the presence/absence of the target as well as the target's frequency or identifiable characteristic.

It should be noted that the upper end of the plug pulling tool 18 defines a connector 92 which is arranged to replicate the upper connector of the Christmas tree 4 (FIG. 1) upon which the well control package 10 is mounted. In the arrangement shown in FIGS. 2, 3 and 4, the well control package 10 is shown adapted for use on a horizontal Christmas tree and as such the connector 92 includes a central production bore 94 and a side annulus passage 96 (FIG. 3). As shown in FIG. 4, the side annulus passage 96 is in communication with the fluid conduit 70 which extends externally of the valve assembly 12 to bypass the valve member 26. Providing a connector 92 in this manner advantageously permits additional components or apparatus which are intended to be coupled to the Christmas tree 4 to still be coupled to the tree, albeit via the valve assembly 12, without the requirement for connection adaptors. Additionally, the provision of the connector 92 advantageously permits a conventional workover riser to be secured to the Christmas tree 4 without requiring the valve assembly 12 to be removed.

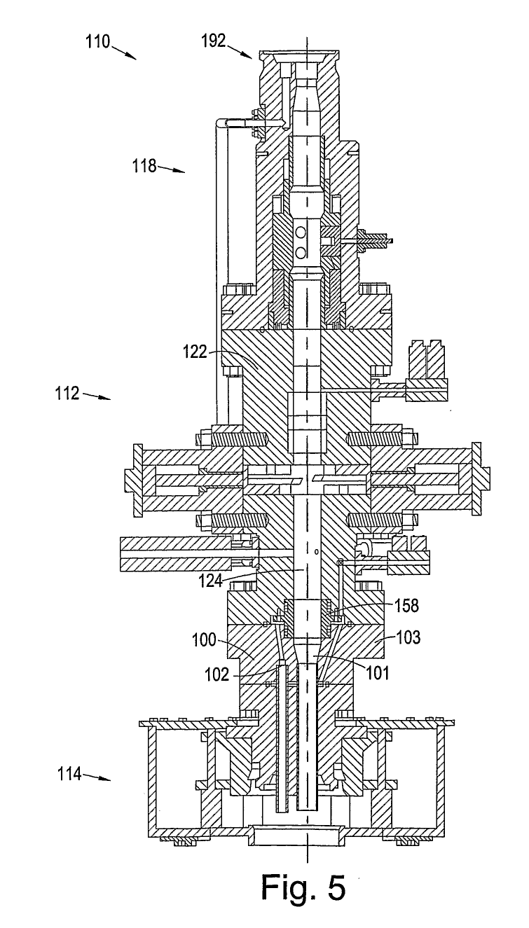

Reference is now made to FIG. 5 of the drawings in which there is shown a cross-sectional view of a well control package in accordance with an alternative embodiment of the present invention. The well control package is generally identified by reference numeral 110 and is similar to the well control package 10 first shown in FIG. 2. For convenience, therefore, like features share like reference numerals, incremented by 100. Accordingly, the well control package 110 includes a valve assembly 112, the lower end of which assembly 112 is secured to a Christmas tree connector 114 and the upper end of the assembly 112 is secured to and supports a plug pulling tool 118. It should be noted that the valve assembly 112 is identical to that assembly 12 first shown in FIG. 2 and as such no further description shall be given.

The well control package 110 in this embodiment is adapted to be mounted on a vertical or dual bore Christmas tree (not shown). Vertical Christmas trees are well known in the art and incorporate parallel production and annulus bores, arranged side-by-side. Accordingly, both the production and annulus bores are off-set from the central axis of the Christmas tree. Thus, as the longitudinal bore 124 of the valve block 122 is centrally aligned, said bore 124 will be off-set from the production bore of a vertical Christmas tree. The valve assembly 112 is therefore provided in combination with a cross-over adaptor 100. The cross-over 100, which will be described in detail below, permits the identical valve assemblies 12, 112 of the present invention to be used on various types of Christmas trees.

The cross-over adaptor 100 incorporates a first throughbore 101 adapted to communicate with both the production bore of a Christmas tree and the longitudinal throughbore 124 of the valve block 122. An isolation sleeve 158 extends between the longitudinal throughbore 124 of the valve block 122 and the first bore 101 of the adaptor 100. The adaptor 100 further incorporates a second throughbore 102 adapted to communicate with the annulus bore of a Christmas tree.

The adaptor 100 incorporates an off-set or eccentric flange connector 103 such that the first bore 101 may extend from an off-set lower position to a centrally aligned upper position. Accordingly, the off-set flange 103 permits the first bore 101 to become aligned with the longitudinal throughbore 124 of the valve block 122 when said valve block 122 is secured to the adaptor 100 via the off-set flange 103.

In the embodiment shown in FIG. 5, the upper end of the plug-pulling tool 118 incorporates a connector 192 which replicates the upper connector of a vertical or dual bore Christmas tree to thus permit any necessary conventional connection to the tree to be achieved without removing the well control package 110.

It should be understood that the embodiments described are merely exemplary and that various modifications may be made thereto without departing from the scope of the present invention. For example, the plug pulling tool may be located below the valve assembly. Additionally, the upper end of the valve assembly may incorporate a suitable connector which may replicate a Christmas tree connector. Furthermore, the location of the ports extending through the side wall of the valve block may be altered.

1. A subsea assembly comprising:
a valve assembly comprising:
a valve block defining a throughbore;
a valve member mounted within the valve block and adapted to be moved between open and closed positions to selectively provide a fluid barrier within the throughbore;
first and second valve stems extending from respective sides of the valve member and through a side wall of the valve block, each valve stem including a sealing region in fluid communication with the throughbore, wherein a cross-sectional area of the sealing region of the first valve stem is substantially equal to the cross-sectional area of the sealing region of the second valve stem; and
a winch assembly mounted relative to the valve assembly and comprising a winch chamber in fluid communication with the throughbore of the valve block, wherein the winch assembly comprises a winch drum carrying a spoolable member adapted to extend through the throughbore of the valve block.

2. The subsea assembly according to claim 1, wherein, in use, the subsea assembly is adapted to be mounted, either directly or indirectly, on a subsea wellhead, such that the valve assembly provides fluid control between the valve assembly and a well bore through the wellhead.

3. The subsea assembly according to claim 1, wherein the spoolable member is adapted to provide support for a downhole tool such that said downhole tool may be deployed and retrieved utilizing the spoolable member.

4. The subsea assembly according to claim 1, further comprising a tool storage assembly mounted relative to the valve assembly and comprising a tool storage chamber in fluid communication with the throughbore of the valve block.

5. The subsea assembly according to claim 4, wherein the tool storage chamber contains at least one downhole tool adapted to be secured to the spoolable member to subsequently be deployed into the well bore.

6. The subsea assembly according to claim 1, wherein the first and second valve stems extend from opposing sides of the valve member.

7. The subsea assembly according to claim 1, wherein the sealing region of each valve stem engages respective stem sealing arrangements adapted to prevent fluid leakage from the throughbore past each valve stem.

8. The subsea assembly according to claim 1, wherein the valve block defines first and second lateral bores extending through an outer wall portion of the valve block and opening into the longitudinal bore, wherein the first and second valve stems extend through the first and second lateral bores respectively.

9. The subsea assembly according to claim 8, wherein the valve assembly further comprises first and second cap members adapted to be secured to the outer surface of the valve block to cover and seal a respective lateral bore.

10. The subsea assembly according to claim 9, wherein each cap member is adapted to receive a portion of a respective valve stem.

11. The subsea assembly according to claim 8, wherein at least one of the cap members defines a stepped bore, with a first bore section of a first diameter, and a second bore section of a second, larger diameter.

12. The subsea assembly according to claim 11, wherein a valve stem sealing arrangement is disposed between a respective valve stem and a respective first bore sections, wherein a fluid cavity is defined between the valve stem and the second bore section.

13. The subsea assembly according to claim 12, wherein the fluid cavity within the cap member combines with or opens into the fluid cavity defined between the valve stem and respective lateral bore in the valve block.

14. The subsea assembly according to claim 1, wherein the valve member is moveable between open and closed positions via at least one of the first and second valve stems.

15. The subsea assembly according to claim 1, wherein the valve assembly further comprises a valve actuator.

16. The subsea assembly according to claim 1, wherein one or both of the first and second valve stems are coupled, either directly or indirectly, to a valve actuator.

17. The subsea assembly according to claim 1, wherein at least one of the first and second valve stems forms part of a valve actuator.

18. The subsea assembly according to claim 1, wherein the valve assembly is adapted to be in fluid communication with a production bore of a Christmas tree.

19. The subsea assembly according to claim 1, wherein the valve assembly is adapted to be in fluid communication with an annulus bore of a Christmas tree.

20. The subsea assembly according to claim 1, wherein the valve assembly permits fluid communication from both production and annulus bores of a Christmas tree through and/or past said valve assembly.

21. The subsea assembly according to claim 1, wherein the valve assembly is provided in combination with an adaptor for permitting use of the valve assembly on various types of Christmas trees.

22. The subsea assembly according to claim 21, wherein the adaptor, in use, aligns the production bore of a Christmas tree with the throughbore of the valve block.

23. The subsea assembly according to claim 21, wherein the adaptor comprises a first throughbore adapted to communicate with both the production bore of a Christmas tree and the throughbore of the valve block.

24. The subsea assembly according to claim 21, wherein the adaptor comprises a second throughbore adapted to communicate with the annulus bore of a Christmas tree.

25. The subsea assembly according to any claim 1, wherein the valve assembly comprises an annulus passage, which, in use, is in fluid communication with an annulus bore of a Christmas tree.

26. The subsea assembly according to claim 25, wherein at least a portion of the annulus passage is formed within the valve block.

27. The subsea assembly according to claim 25, wherein at least a portion of the annulus passage is formed externally of the valve block.

28. The subsea assembly according to claim 25, wherein the annulus passage by-passes the valve member.

29. The subsea assembly according to claim 1, wherein the valve block of the valve assembly comprises at least one port in a side wall thereof, wherein the at least one port permits fluid access into/from the throughbore of the valve block.

30. The subsea assembly according to claim 1, wherein the subsea assembly comprises a connector which replicates a Christmas tree connector.

31. The subsea assembly according to claim 1, wherein the valve assembly further comprises a shearing arrangement adapted to shear a solid object.

32. The subsea assembly according to claim 1, further comprising a sensor adapted to sense the passage of an object therethrough.

33. The subsea assembly according to claim 32, wherein the sensor is mounted within the throughbore of the valve block, below the valve member.

34. A valve assembly comprising:
a valve block defining a throughbore;
a valve member mounted within the valve block and adapted to be moved between open and closed positions to selectively provide a fluid barrier within the throughbore; and
first and second valve stems extending from respective sides of the valve member and through a side wall of the valve block, each valve stem including a sealing region in fluid communication with the throughbore, wherein a cross-sectional area of the sealing region of the first valve stem is substantially equal to the cross-sectional area of the sealing region of the second valve stem.

35. A subsea assembly comprising:
a valve assembly comprising a valve block defining a longitudinal throughbore adapted to be in communication with a wellbore and a lateral bore extending through a wall portion of the and opening into the longitudinal bore to be in fluid communication therewith and with the wellbore; and
a winch assembly mounted above the valve assembly and comprising a winch chamber in fluid communication with the throughbore of the valve block, wherein the winch assembly comprises a winch drum carrying a spoolable member adapted to extend through the throughbore of the valve block.

36. The subsea assembly according to claim 35, wherein the bore defines a well-kill fluid bore adapted to permit well-kill fluid to be communicated into the subsea assembly.

37. A cross-over adapted to be coupled between a dual bore Christmas tree and a subsea assembly, said cross-over comprising:
a body portion adapted to be secured to a Christmas tree;
a flange portion formed with the body portion and adapted to be secured to a subsea assembly; and
first and second throughbores extending through the body and flange portions wherein said throughbores are off-set from a central axis of the body portion;
wherein the flange is off-set from the body portion such that the first throughbore bore is aligned with a central axis of the flange.

38. A subsea tool deployment assembly comprising:
a subsea assembly comprising:
a valve assembly comprising:
a valve block defining a throughbore;
a valve member mounted within the valve block and adapted to be moved between open and closed positions to selectively provide a fluid barrier within the throughbore;
first and second valve stems extending from respective sides of the valve member and through a side wall of the valve block, each valve stem including a sealing region in fluid communication with the throughbore, wherein a cross-sectional area of the sealing region of the first valve stem is substantially equal to the cross-sectional area of the sealing region of the second valve stem; and
a winch assembly mounted relative to the valve assembly and comprising a winch chamber in fluid communication with the throughbore of the valve block, wherein the winch assembly comprises a winch drum carrying a spoolable member adapted to extend through the throughbore of the valve block; and
a tool storage assembly mounted relative to the subsea assembly and comprising a tool storage chamber in fluid communication with the throughbore of the valve block, wherein the tool storage chamber contains at least one downhole tool adapted to be secured to the spoolable member.
